(19) United States
(12) Patent Application Publication
(10) Pub. No.: US 2016/0023118 A1
(43) Pub. Date: Jan. 28, 2016

(54) METHOD AND SYSTEM FOR LIVE ACTION SPORTS GAME

(71) Applicant: Barry Mindes, Boynton Beach, FL (US)

(72) Inventor: Barry Mindes, Boynton Beach, FL (US)

(21) Appl. No.: 14/807,222

(22) Filed: Jul. 23, 2015

Related U.S. Application Data
(60) Provisional application No. 62/028,103, filed on Jul. 23, 2014.

(51) Int. Cl. A63F 13/65; A63F 13/44; A63F 13/798; A63F 13/828; A63F 13/46

(52) U.S. Cl. CPC A63F 13/65; A63F 13/828; A63F 13/46; A63F 13/798; A63F 13/44

(57) ABSTRACT

A system and method for administering a live action sports game in which a live sports game is displayed and a virtual game associated with the live sports game is established including players of the live sports game based on defined game scoring rules and strategies. A virtual team of players from two or more of the live action sports games is selected. A virtual team score from received statistics of the live action sports game as a sum of points actually scored by the virtual team of players and bonus points for team play that directly contributes to scoring and/or the prevention of scoring. Optionally a player bonus points based on popularity of a player is determined. The live action sports game can optionally include substituting one or more player of the virtual team of players, calling one or more plays used in the live action sports, calling one or more play risks taken in the live action sports games, and calling one or more substitute players to participate in a play call in the live action sports games. A ranking of the virtual team score in comparison to a ranking of one or more competitor virtual team scores can be determined and displayed.

### BACKGROUND OF THE INVENTION

1. Field of the Invention

The invention relates to a system and method for administering a live action sports game, and more particularly to a display of an associated live sports game and administering a virtual game including players of the live sports game based on defined game scoring rules and strategies.

2. Description of Related Art

Internet sports contests currently operate under the Unlawful Internet Gambling Enforcement Act (UGIEA). Cash prizes can be awarded under the Act for fantasy sports as games. The cash prizes add excitement to the games.

In conventional fantasy sports the gamer is the putative team owner and he has a budget with which to create his fantasy team, using real players playing live sports. The players have prices associated with them, established by the fantasy league, in a player auction, or otherwise. The fantasy gamer does his best to use his budget to select players he believes will create the most competitive team possible. To do this he relies on his judgment, sports league statistics, advice of experts, weather, and the like. Judgment is particularly important as there is little data on specific player match-ups, a major factor in player performance, as teams do not play each other often in a single year and rosters can change considerably between seasons. Player health and psychological condition can also be a factor and the effect of that is difficult to foresee or can only be learned from a player's performance on the day of the game. Yet the current fantasy player picks his team, and it remains static, during the game.

There is also a proscription in the Internet Gambling Act that prohibits a fantasy team from being too dependent upon a single team or player as that is thought to bring fantasy games too close to illegal sports gambling. Those factors and competition in player selection leads fantasy teams to include players from many live teams. Some current fantasy leagues moreover allow a single live player to be on only a single team in the league. Team performance in fantasy play is determined by how well the selected players perform in their real game(s). Often in conventional fantasy play only offensive play is included as an effective factor in the game. Yet in real sports defense is often the determinant as to which team wins the game. This is a limitation to the relationship between conventional fantasy play and real sports.

In conventional fantasy play points are assigned for achieving certain goals, such as in American football, completing a pass or a run of a certain distance, or reaching a certain base on a hit in baseball, and the like. Such accomplishments often have little relationship to scoring in live games. Only actual scoring counts.

In conventional fantasy play the pools of players from which fantasy sports teams are drawn are actually on many different teams and they cannot cooperate in those aspects of the underlying games that demand cooperation. Thus conventional fantasy play does not simulate real play in team sports in which cooperation is central to success. The present system and method includes having player groups on the same team who can cooperate. It is desirable to provide a method and system that converts fantasy sports into a live video game that is played concurrently with the live games and gives the gamer the ability to influence fantasy game outcomes derived from live game play.

### SUMMARY OF THE INVENTION

The present invention relates to a system and method for administering a live action sports game in which a live sports game is displayed and a virtual game associated with the live sports game is established including players from the live sports games, based on defined game scoring rules and strategies. In the method and system for live action sports game of the present invention, a team score is the sum of the points scored by the live players on their fantasy team, not artificial points for yards gained or bases reached as in conventional fantasy games, as those points are often not scoring related. Bonus points can be awarded in the present invention to one or more players or groups for assistance that directly contributes to team scoring when those players or groups do not score themselves. Bonuses are also awarded when players or groups directly prevent the opponents from scoring, which reduces the opponents score.

The system of the present invention includes a display such as a TV, smart phone, PC, laptop, notebook, Pad computer and the like to display the live sport with which the fantasy game is associated currently, switching channels automatically under system control, or gamer control, depending upon the capabilities of the display the gamer is using, to follow the live action associated with the virtual game when the gamers players are in varying games. The method and system for the live action sports game is played contemporaneously during the displayed live game.

The values of players in the present invention can be derived from their selection popularity not a draft or prices set by experts. The value is reflected in a bonus that a less popular player gets for accomplishing the same goal as a more popular player might, in addition to the points his team gets for the actual points scored. For example, a player half as popular as the most popular player in their position might get twice the points the most popular player gets for accomplishing the same feat. For example, if they both scored a touchdown, the most popular player would get 7 points including the extra point. The player half as popular would get, for example, 14 points; 7 points for scoring the touchdown and a bonus of 7 points because the gamers deemed him half as capable according to selection popularity.

The present invention can determine and display a team's rank during the contest on the display. The gamer therefore is prepared to plan his strategy considering his team's score relative to its opponents.

The gamer can substitute one or more players or groups from his roster, and call plays, attempting to improve his team's chances as game conditions change. The gamer can also take extra risks for large scores. The gamer is in effect the coach. That maintains interest for all players, even those far behind.

The method and system for live action sports game can turn any sport or game into a video game and also provides the operator with an active sales platform as players are on line for the entire live game. This open line also allows the gamers to check and negotiate roster trades to be effective in the second half of football or the last 3 innings in baseball, as examples.

In one embodiment, the live sports game is American Football, the most popular fantasy game. Other live sports are analogous to football in the present context. The present invention can be configured for almost any live sport and most other types of contests and competitions.

In the present invention as mentioned above, the gamer serves as both the team's General Manager and Coach. The gamer selects the team's players and to a substantial extent, through substituting players, calling plays and by taking large risks to achieve major improvements in the team's prospects and controls its fortunes. That is what a live team's coach does. For example, in baseball the manager might walk the bases loaded, risking giving up extra runs, to get to pitch to a less competent batter or set up a force-out at any base. Or in American Football throw a pass a great distance into a heavily defended end zone to create an opportunity for one of his outnumbered receivers to catch a pass or deflection by out jumping the more numerous defenders, and allow the gamer's team to score a game saving or winning touchdown as time is running out.

There are other problem aspects of conventional Fantasy sports that the present invention addresses as it strives to present a computer game that is as close a simulacrum to live sports as possible. For example, in conventional fantasy football, how does an end is on one team and the quarterback is on another complete a pass, or the second baseman and shortstop on different teams complete a double play with a first baseman who might even be on a third team? There are huge numbers of similar cases across most team sports. The player groups in the present invention allow that cooperation.

There is also a potential problem posed by having the conventional fantasy teams be composed of live players from the same player pool. That might lead to significant duplication of popular players on the various fantasy teams and thus to similar scoring by multiple teams. This can be avoided by having a draft and players allowed on only one team as in some conventional fantasy games. But that severely restricts the number of teams possible in a single league which, in the case of cash prizes, substantially restricts the sizes of the prizes as those come from the funds accumulated from the game fees paid by the players. Plus much of the excitement of fantasy comes from having teams of players with whom the gamers have attachments or confidence in their ability. Remove that and the excitement and allure of the game, and therefore the size of the audience, can substantially diminish. The present invention ameliorates that problem in its game by substitution of players, play calling, substituting plays, and the like, that results in teams with identical players often achieving different results.

The present invention removes most of the problems with conventional fantasy play, elevating it from a mere exercise in hoping that a group of disparate players, for which there is a paucity of reliable data, will compete better than might be expected against many different fantasy teams, with unfamiliar match-up and unexpected weather conditions, using players possibly having physical/personal problem.

The present invention allows the use of player groups on the same team that do cooperate in the normal course of their play. In doing this there is one caveat. As noted above, fantasy sports are regulated by the (UGIEA). That Act specifies that fantasy teams cannot be too dependent upon a single team or player. To comply, the present invention in one embodiment restricts the use of players from the same live team, or a single player, to half of a game, or less, on a fantasy team, as one example, out of other possibilities.

In summary, conventional fantasy sports games are a vapid representation of real live team sports games, the only games to which they are associated. They:

a) Do not allow for cooperation among teammates, the sine qua non of team sports;

b) Provide a means of substituting players from a team's roster to accommodate changed game conditions or to replace players who are not performing well;

c) Use scoring rules that have little relationship to scoring in real sports; and

d) Do not allow the gamer to exercise any control over his teams strategic goals.

Conventional fantasy sports is merely an exercise in using a budget, and statistics that might not apply well to specific games or a players condition, to select players for a phantom team that the gamer hopes will individually perform better than expected. Conventional fantasy sports games have little or no nexus to real live team sports.

The system and method of the present invention allows the gamer to substantially control most of the essential management responsibilities required in real sports and does it in a direct relationship to live games. It converts fantasy sports to a valid simulacrum for real live sports. The gamer team comes close to actually playing a real live game.

The invention will be more fully described by reference to the following drawings.

### BRIEF DESCRIPTION OF THE DRAWINGS

FIG. 1 is a schematic diagram of a system for administering a live action sports game.

FIG. 2 is a flow diagram of a method for administering a live action sports game.

FIG. 3 is a schematic diagram of an example computing environment for administering a live action sports game.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

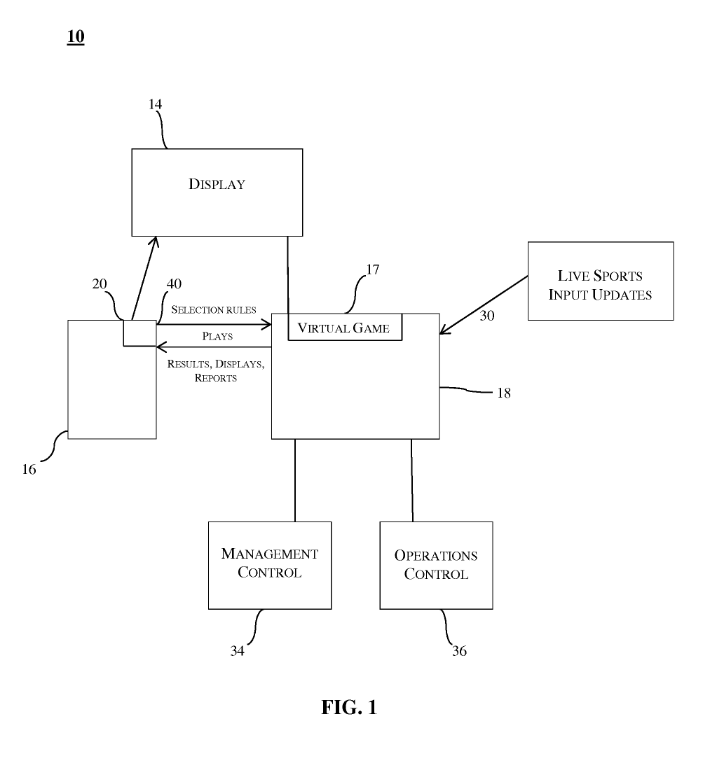

In system 10 of the present invention shown in FIG. 1, display 14 displays one or more live action sports games. User interface 16 interfaces with virtual live action game 17 running on live action game processing system 18. User interface 16 can include graphical user interface 20 to display 14 for switching channels automatically under system control, or gamer control, depending upon the capabilities of the display the gamer is using, to follow the live action associated with virtual game live action game 17. For example, display 14, user interface 16 and system 18 can be an integrated system of one or more of a TV, smart phone, PC, laptop, notebook, Pad computer and the like.

In a preferred embodiment, display 14, user interface 16 and system 18 can be integrated in a large screen smart phone to allow both viewing of live sports contests and playing the virtual live action sports game on the same hand-held large screen smart phone. In an alternative embodiment, smaller screen phones can be used for user interface 16 while viewing the live games on a television for the larger image. The application software options for creating the virtual action sports game can include standard products like Dot Net, Java, C++, and the like with a report writer and a data base server and server language.

Live action game processing system 18 receives input data 30 on live sports play and results. Management control 34 and operational control 36 can be determined by the method of the present invention described below. Inputs 40 from interface 20 can be communicated to live action game processing system 18. For example, inputs 40 can include player selection, player groups, team rosters and substitutes, play calling, play risk call, and substitute play calling. Management control 34 and operational control 36 can include input for game play, game scoring and team rankings. Outputs 42 can be presented through graphical user interface 20 to user interface 16. Outputs 42 can include scoring, team rankings, result, displays, and reports.

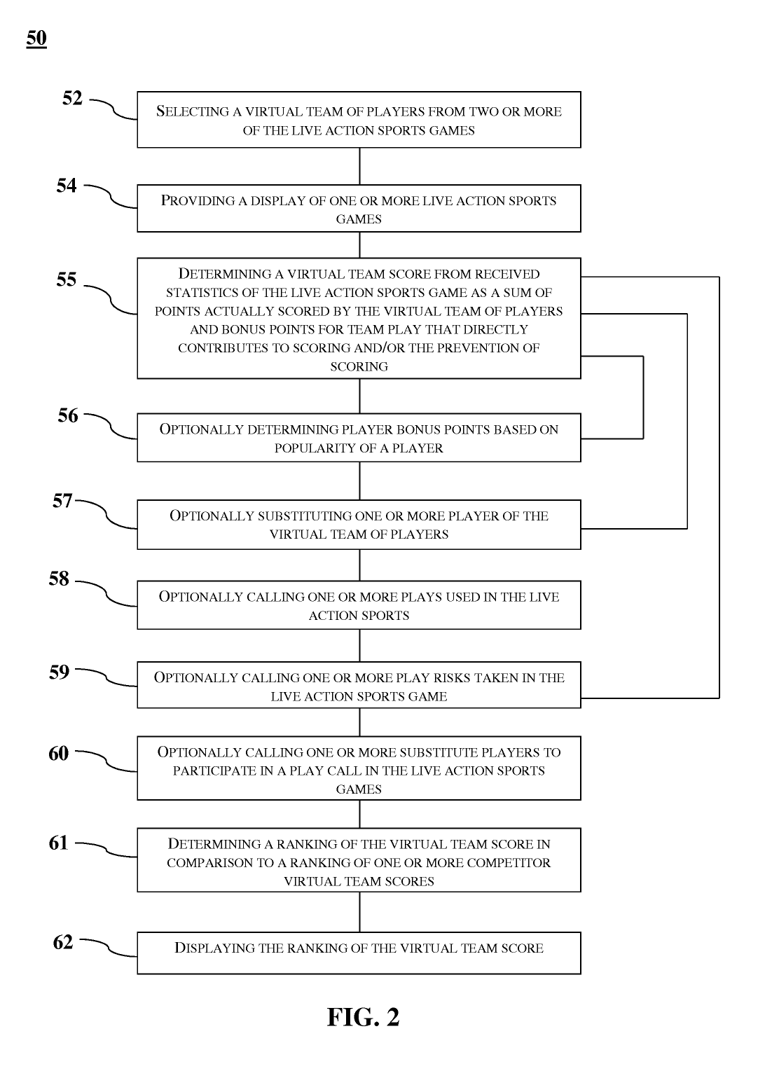

FIG. 2 is a flow diagram of method 50 for allowing a user to play a virtual live action sports game. In block 52, a virtual team of players from two or more teams of live action sports games is selected. In block 54, one or more of the live action sports games can optionally be displayed during play of the live action sports games. In block 55, a virtual team score is determined from received statistics of the live action sports game as a sum of points actually scored by the virtual team of players and bonus points for team play that directly contributes to scoring and/or the prevention of scoring. In block 56, a player bonus points is optionally determined based on popularity of a player, the player bonus points being included as a factor in block 55 for determining the virtual team score. In block 57, one or more player of the virtual team of players can be optionally substituted. In block 58, one or more plays used in the live action sports games can be optionally called and points being included as a bonus factor in block 55 for determining the virtual team score if said one or more plays is called for the virtual team of players. In block 59, one or more plays risks taken in the live action sports games can be optionally called and points being included as a bonus factor in block 55 for determining the virtual team score if said one or more play risks is called for the virtual team of players. In block 60, one or more substitute players is called to participate in a play call in the live action sports games and points being included as a bonus factor in block 55 for determining the virtual team score if the one or more substitute players participate in the selected play call for the virtual team of players.

In block 61, a ranking of the virtual team score in comparison to a ranking of one or more competitor virtual team scores is determined. In block 62, the ranking of the virtual team score is displayed.

### Player Selection

As an example of player selection meeting the Act's requirements to be used in method 50, if a fantasy football team were to select offense and defense players from only 2 teams, a total of 22 players, then half would have to come from each team. That satisfies the team requirement. Since at least two televised games (4 teams) are always playing simultaneously in most markets each weekend, 2 other teams can also contribute players so the requirement is readily satisfied.

### Player Groups

It is usual that numbers of players, in their normal functioning, often assist each other in accomplishing their playing goals. In many cases, those goals cannot be accomplished without cooperation; in others they are more readily accomplished. In most team sports players cooperate to accomplish their objectives. For example, in both American Football and basketball, players are required to complete passes. Zone defenses are often used to interdict the offense's plans, while offensive players set screens and run offensive patterns that “pick-off” defenders from locations. These defenses involve several players, usually 3 or more working in concert. In baseball, double plays usually require 3 players, pickoff plays 2 players, relay tag outs at least 2 players, and the like. In soccer and hockey the goal keepers and goalies are often assisted by other defenders. In American football, several offensive linemen cooperate with the blocking back to open a “hole” in the defender's line for the ball carrier to run through.

These are only a sampling of the cooperative action used in most team sports. Good defense and most offense are impossible without cooperation.

The following are examples of player groups to be used in method 50 that can be employed in several sports:

Football: blocking backs with quarterbacks and running backs, on pass and run plays
Defensive backs and safeties, on pass defense
The offensive line, always included from the quarterback/running back's team, with the quarterbacks, running backs
Defensive line, linebackers, safeties, to create hurries and sacks
Quarterbacks, flankers and running backs, on passes

### Baseball:

Pitcher and catcher
First baseman and every other infielder, on ground outs and base running outs

### Hockey:

Center and wings, on assists
Goalie and defense men, on goal defense

### Soccer:

Goal keeper and defense men, on goal defense
Strikers, forwards and mid fielders, on shots on goal
There are analogous groupings present in almost all sports.

### Team Roster and Substitutes

Substituting players to increase a team's potential is part of the gamer's role and can be used in method 50. With 2 games there are 4 teams playing (8 combined offenses/defenses in sports that include different players on offense and defense). Therefore a team in those sports may have 4 players/groups each for offense and defense roles on its roster. It will be appreciated that it is impossible to have the offense and defense from the same live team playing each other.

As stated above, with 4 live teams playing simultaneously in each market there could be significant duplication of players, which could lead to duplicate scores on those Phantasmagoria teams. However, with player substitutions, play calling, play call risk taking, substitute play calling, and the like, of the present invention, team score duplication should be low as gamers will each individually direct their own team's strategies, which should be dependent upon the specific conditions in those games, i.e., the score, game clock, etc. And in any case, while duplication decreases the sizes of the prizes, that is compensated for by the increase in the number of winners.

### Scoring

The present invention is a live action computer game. It is played against a backdrop of live contests, the most common ones being sports events, which are viewed by the gamers while simultaneously playing the present invention. It can also be played without its live action aspects, but in that version much of the strategy and excitement of the game is diminished.

In the present invention, a teams' score is the sum of points actually scored by its players and bonus points for team play that directly contributes to scoring and/or the prevention of scoring. For example, an American football player might run from the ball from his own 1 yard line to the opponent's 1 yard line, a distance of 98 yards. But if his team is then unable to cross the goal line his run has no effect on live scoring, regardless of how noteworthy his effort. On the same note, if a football team recovers a fumble from its opponents on their 1 yard line and one of its players takes the ball across the goal line on the next play, gaining only 1 yard, the team scores a touchdown. That is the essence of real team sports. Conventional fantasy play has scoring based upon individual player performances, not actual scoring, the runs or passes of a certain distance, bases reached, and the like, in football and baseball.

As examples of contributing directly to scoring and/or its prevention, in American football, if a defender intercepts a pass, he has provided his team with the opportunity to score points that they wouldn't otherwise have had because the other team would have still been in possession of the ball. He also deprives the other team of the opportunity to score points on the offensive downs that would have remained for them. His team in the present invention is therefore awarded a bonus dependent upon the actual number of points that his team scores subsequently on the ensuing downs with which they were provided: for example 40% of the points that they score on those downs could be the bonus. His team would also receive a bonus for having prevented the scoring their opponents could reasonably have been expected to have made on the downs that they were prevented from using. For example, the recovery of a fumble within 20 yards of a team's goal line by a defender while his opponents still had a down(s) remaining, and were likely to have scored at least a field goal, would produce bonus points for the defenders. That bonus might, for example, be equal to the smallest number of points that they were likely to have scored, say 3 points for a field goal in this case. There are other similar bonuses possible in football and other sports for such types of defensive contributions. For example, a sack of a passer or a “stuff” of a run, both of which did not gain any yards might be awarded 1 point each because not only did they prevent any yards being gained, but might also might cause the opponents to change their offensive strategy to better protect their offensive players, thereby rendering their offense less effective.

After selecting a roster the gamer acts as the team coach (manager and the like, as appropriate to the sport). The gamer can then exercise some or all of the following in run strategies:

1. Player/group substitutions

2. Play calling

3. Play call risk taking

4. Substitute play calling. As examples, call for a field goal try, a run or pass try, pinch hit, and the like, that the gamer calls for using a substitute player from his roster that he designates, say for use on the first opportunity, or in a comparable situation, that the substitute player runs the play called. The Gamer gets the result of the substituted play and/or any play in that sequence of plays.

5. Special calls. Special calls might be allowed at special times in a game, for example during the final 2 minutes in a football game, the last inning of a baseball game, extra time in soccer, and the like.

Substitutions might have special conditions like what happens if the substituted player never gets into a game, how many times a player might be substituted, when substitutions might be allowed, at game period breaks and the like.

### Player/Group Substitution Timing Considerations

Players can be substituted in method 50. With four teams playing simultaneously, there could be some 30 players on a roster.

The fantasy team gets the result of the substituted player/group's performance on say their next involvement in the substituted play called for and the other plays that follow in that play sequence, until the change in possession. If his substituted player doesn't get involved in the necessary play then the gamer might get the result that he would have had if no substitution had been made but use up a call.

1. In all substitutions of players on the teams of the present invention the system insures that the UGIEA proscriptions on the time of use of players are satisfied.

### Play Calling

Plays in football are, of course, called by the quarterback, coach, his assistants, and the like. However, the gamer will often have his own view as to what play should be called. In the present invention the gamer is afforded the opportunity to specify the play which he believes should be called. If the play he specified is called and it is successful according to the present method and system for live action sports game's criteria, for example say a run of 5 yards or a pass of 5 yards in American Football is achieved, or a base runner advances one base on a hit and run or a sacrifice, or the like, the present method and system for live action sports game's team would get, say, a 1 point bonus. If the specified criteria were not met the gamer would get no points and use a call. If the gamer called for a pass and a run was made that was not successful, according to the criteria for a run, the gamer might get 2 points and not use a call, it being assumed that the defense was set for the unsuccessful run and therefore the pass the gamer called would likely have been successful. If the run were successful the gamer would use up a call. The points shown above are, as are all of the various scoring schedules given herein, only examples and might be replaced or modified when the game is put into live service. The gamer will have a limit on the number of calls he can make in a fantasy game.

### Play Risk Taking

There might be times during a game to be used in method 50 of the present invention that the gamer might be particularly confident in his judgment or his team might lag in the ranking, and the like, and he would like to take some risk on the possibility that a call might be correct, or better, than that made in the live game. He could then chose to use up to, say, 4 picks for his call and receive 4 times the point reward if his call is correct or better than that made in live play.

### Substitute Play Calling

In addition to play calling in conjunction with the actual live calls made by the coach and his assistants, the present invention includes live play calls made by the gamer, using substitutes on his roster for the play that the gamer wishes to have run to be used in method 50. Depending upon the play that is run on the field, the gamers' play might not have any relationship to the play called by the coaching team. It is a substitute for the live play using the designated substitutes, in the game in which they are playing. It takes place, for example, the first time that the substituted player(s) run a play meeting the gamers' call requirements, say a pass or run of a certain distance. The results achieved on the gamers play are substituted for the results from the live game it replaces. The examples of special substitute play calls shown below are intended to clarify the subject.

Substitution examples Inside of the 2 minute warning period in football, the last inning in baseball, the last 2 minutes of play in basketball, in extra play in soccer, and the like, might be treated specially. For example, the gamer might be allowed to use up all of his remaining calls on a substitute play call and get the proportionate points if the play is successful.

### Baseball

The gamer might designate, say, 2 players as the pinch hitters on his team. He can substitute one of them for the player about to go to bat, using the designated pinch hitter, say, the next time he is at bat in his game. Any players on the substituted team on base at the time of the substitution would advance a number of bases equal to the base(s) advanced by the substitute player himself, during the pinch hitter's at bat and get any runs scored during that at bat. The substituted player will continue to play until he scores, is out, or until the end of the inning. A designated substitute batter might be allowed only once in a game. The gamer might not receive any other scores while the pinch hitter is involved in the at bat, until he scores, or the inning ends. This is only one possibility of how the substitution might be implemented.

There are substitution possibilities in most sports.

The design options discussed above do not substantially change the basic structure of the game and the specific details of the design will be decided upon, along with other similar feature of the game as experience with the game dictates.

### Live Game Scoring

In addition to the special scoring discussed above, the gamer gets any scores made by the live players on his team at the time the score is made to be used in method 50. The exception for other scoring after any call is made is always in force when appropriate.

### Defensive Scoring

In many sports the defense can on occasion score points in the normal course of play. As examples, a defense man may intercept a pass or recover a fumble and score in American football. In tennis a player can score on his opponents serve. In soccer or hockey a player might inadvertently send the ball or puck into his own goal, among other examples. The gamer receives the points scored by the defense in the normal course of live play to be used in method 50.

### Defensive Contributions to Scoring

In many cases the defense directly contributes to the prevention of a score, such as blocking a direct shot on goal in soccer or hockey, blocking a field goal in football, blocking a pass within say 10 yards of the end zone in football, blocking a shot within the circle in basketball, reaching over the wall to catch a baseball going over the wall, etc. These preventions of scores actually count the same as scoring itself because they reduce the opponents score by the number points prevented and might be so rewarded.

There is another set of defensive contributions to scoring that are less direct but none the less are significant. Intercepting the ball or recovering a fumble and not scoring still deprives their opponents of the additional downs they would have had to score points. It might also have given the team that recovered the ball a field position superior to that they were likely to have received on a punt, both examples from American Football. In baseball, a pitcher striking out a batter prevents him from putting the ball into play and scoring or assisting in scoring. Similarly, a double play, catching a runner stealing or trying to gain an extra base, and the like prevent future scoring opportunities. In basketball, blocking a shot or pass near the basket might also prevent the opponents from scoring, etc. Yet the contributory defensive plays are only significant if the offense taking over after the turnover scored on the ensuing possession or directly prevents a score, like catching a hit in baseball that is over the wall. A score contributing defensive play, like recovering a fumble, should be entitled some points for creating the scoring possibility. The offense would still receive the points for scoring. The defense that created the opportunity to score can be rewarded. For example, the defense can receive, for example, 60% percent of the value of a score if they recovered the ball inside the opponent's 3 yard line, 40% if they recovered the ball inside the 20 yard line, and the like. All of these defensive contributions, plus others like blocking a punt or field goal attempt, are readily amenable to analysis based upon historical outcomes from these defensive contributions to determine the proper reward and can be factor in the game to be used in method 50.

### Team Rankings

Integral to preparing and prosecuting a strategy for maximizing your chances of doing well, if not winning, any type of contest is knowing how well you are doing on a timely basis throughout the contest. Otherwise you might not be able to react rapidly to changing circumstances that affect your team's prospects relative to the other contestants. The present invention can provide its gamers with their team's current score, its position in the contestant's ranking and the elapsed time in the contest, all at a rate consistent with meaningful changes in those measures, as appropriate for each contest. With this information, displayed on the gamers' screen, the gamer, can use that data, and, knowing the strengths and weaknesses of his team and understanding the tools at his disposal, discussed above, can take appropriate action and any risks necessary to maintain or improve his team's prospects.

### Contests Covering Multiple Games

In many sports there are contests that extend over multiple games, like the World Series in baseball, March Madness in college basketball, the World Cup in Soccer, The NFL playoffs. The present invention supports those types of competitions by, for example eliminating losing teams in elimination competitions, accumulating points in total point competitions, and the like, as appropriate for the competition type.

### Playing the Present Invention

Playing the present invention in its most satisfactory manner requires being in an environment in which you can see the live games while simultaneously communicating on line, in real time, with the present invention's hub, to receive its updates for your contest and for the gamer to communicate his intended course of action for his team. The live sports events will be received streamed via the internet, from a satellite or cable link or even from broadcast television to display 14. The streamed channel is best because television channels can be switched automatically to the appropriate channel under management controls. However doing so manually is simple as there are only 2 channels involved on our basic service, which can be switched back and forth using just the “previous” button on the TV remote in a second or so. In all of these transmission modes the possibility of transmission delays will be considered and techniques will be employed to prevent past posting by players receiving play results faster than the hub's data distribution speed. Such techniques currently exist.

In the larger contests of the present invention, which require more simultaneous live teams to be involved, the players will need a package of sports channels when more than two channels are needed. Allowing more live teams that play simultaneously provides a larger pool of players for the gamers to draw their teams from, and has an even smaller chance of partial team player duplication. But it will require manual channel changing unless a deal can be struck with the TV provider.

An issue can arise when changing from offense to defense and back in discontinuous sports, such as American Football which use two different teams in those roles. All switches between offense and defense and vice versa commence at the start of the upcoming offense or defense sequence, i.e. on the first down of the offense or defense sequence of the team switched into as the game that is switched into may be in the middle of a play sequence when the substitution was called for. There could also be rules that permit switching only at certain times, e.g., at the start of an offensive or defensive series in the present live game.

To prevent a gamer from observing several games and gaining an advantage in switching games, he might be required to specify the offense or defense that he wants next to switch into some significant time before he makes any switch, The game the gamer sees on his display is that which shows his team's offense or defense.

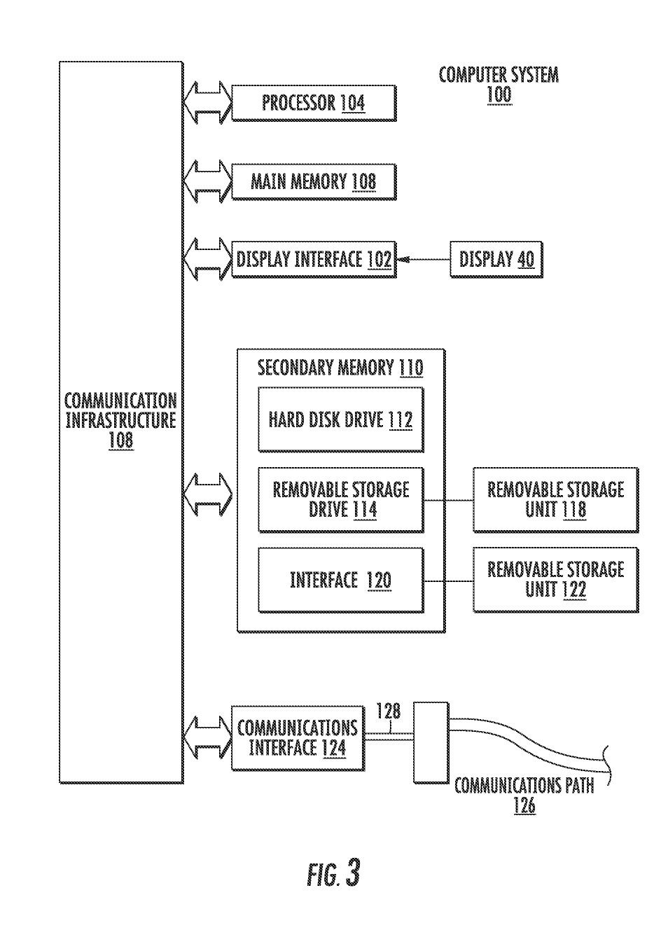

A single contest of the present invention, might include, depending upon the sport, the sophistication and size of the audience, and the like, any number of special features, from only selecting players, through including some or all of the in run play options such as substitutions, player groups, play calling and risk taking. FIG. 3 shows a computer system 100 that includes one or more processors, such as processor 104. The processor 104 is connected to a communication infrastructure 106 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on the display unit 40. Computer system 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative embodiments, secondary memory may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100.

Computer programs (also referred to as computer control logic) are stored in main memory 118 and/or secondary memory 110. Computer programs may also be received via communications interface 124. Such computer programs, when executed, enable the computer system 100 to perform the features of the present invention, as discussed herein. In particular, the computer programs, when executed, enable the processor 104 to perform the features of the present invention. Accordingly, such computer programs represent controllers of the computer system 100.

In an embodiment where the invention is implemented using software, the software may be stored in a computer program product and loaded into computer system 100 using removable storage drive 114, hard drive 112, or communications interface 124. The control logic (software), when executed by the processor 104, causes the processor 104 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s). In yet another embodiment, the invention is implemented using a combination of both hardware and software. It is understood that the exemplary environment illustrated in FIG. 3 is not intended to limit the present disclosure, and that other alternative hardware and/or software environments may be used without departing from the scope of this disclosure.

In one embodiment, data for use in the computer system 101 is, for example, input and/or accessed via user interface 16, such as a personal computer (PC) minicomputer, mainframe computer, microcomputer, telephonic device, or wireless device, such as a hand-held wireless device coupled to a server, such as a PC, minicomputer, mainframe computer, microcomputer, or other device having a processor and a repository for data and/or connection to a processor and/or repository for data, via, for example, a network, such as the Internet or an intranet, and couplings. The couplings include, for example, wired, wireless, or fiberoptic links. In another embodiment, the method and system of the present invention operate in a stand-alone environment, such as on a single terminal. For all data received or transmitted under the present invention, such as player statistics and team scores, may be calculated based on values input, which may be manually input or downloaded from a database at any location, preferably remote. The database itself can be online, stored in fixed memory, or disk-based.

If desired, the software can be configured to allow individual public users to interact with the system to select virtual teams and that also displays information providing the performance status or current total points of individual players. The display will be generated and will include information that the public users can view to monitor the state of their team scores as the games and individual players perform in their respective real-life games. The software can receive this data feed continuously from a data source that distributes game performance statistics or a source that distributes points for player performance.

The software can be implemented on a server and may communicate with client devices such as mobile devices or PCs over a computer network. A browser-based interface may be implemented by the software that permits public users to communicate with the servers using HTML, SHTML, JAVA, IFRAME, or other Internet protocols if desired. In a mobile implementation, a resident application can be implemented on the mobile device that generated a GUI for the fantasy game based on interaction with the server. Communication can for example be conducted using Mobile devices and iPhones or Android devices can use conventional communications to carry out and drive the GUI and the service. The server can include one or more servers and may use or include a database that is local or remote. A firewall or other security protection may also be implemented. The server may also communicate with lottery servers or equipment such as to communicate user or financial data. The software is implemented on this equipment and network (e.g., Internet, mobile network, private network) and when implemented provides the public users with a fantasy football game as a new enhancement in the set of available interactive game features available to users.

The online live action sports game system, computing devices, databases, or other discrete software or hardware components can communicate and are arranged to carry out the illustrative processes and applications described herein by way of sending a signal such as a packet, digital message, or a command within a communication to or between components (and act in response to the receipt of a signal to carry our processes) and between or through supporting software or hardware such as communicating with an operating system, communicating with another resident application through an API or the like, communicating between network elements using an Internet protocol or one or more layers of the OSI model, or communicating through an intermediate component.

A computing device can include a computer, computer system or other programmable electronic device, including a client computer, a server computer, a portable computer (including a laptop and a tablet), a handheld computer, a mobile phone (including a smart phone), a gaming device, an embedded controller and any combination and/or equivalent thereof (including touchless devices). Moreover, the computing device may be implemented using one or more networked computers, e.g., in a cluster or other distributed computing system. It is understood that the exemplary environment discussed and illustrated is not intended to limit the present disclosure, and that other alternative hardware and/or software environments may be used without departing from the scope of this disclosure. The present techniques can be applied to devices other than hand-held devices, such as laptops or desktop computers.

Further, the terms “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

The local storage can include volatile memory (such as RAM) and/or non-volatile memory (such as ROM as well as any supplemental levels of memory, including but not limited to cache memories, programmable or flash memories and read-only memories). The computing device or handheld device can include one or more processing devices (e.g., one or more central processing units (CPUs), one or more graphics processing units (GPUs), one or more microprocessors OM and similar and complementary devices) and optional media devices (e.g., a hard disk module, an optical disk module, etc.). Additionally, any storage techniques used in connection with the presently disclosed method and/or system may invariably be a combination of hardware and software.

One or more features illustratively described herein can be implemented individually or in various combinations. The present system, method, or related inventions also relate to a non-transient computer readable medium. The application can be set of instructions readable by a processor and stored on the non-transient computer readable medium. Such medium may be permanent or semi-permanent memory, such as hard drive, floppy drive, optical disk, flash memory, ROM, EPROM, EEPROM, etc., as would be known to those of ordinary skill in the art.

Features or characteristics described in one context, process, or device are applicable to other context, process or devices described herein. The steps of the processes illustratively described herein can be performed in a different order, if desired. Also, steps could be added or removed from the processes illustratively described herein. The processes or steps illustratively described herein can be implemented in software and data (in computer readable medium, transient and/or non-transient) using the described examples of hardware and network configurations.

The verb “may” is construed to mean that, although this is one way of practicing the presently disclosed invention, it is not limited to that example.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A computer-based data processing method for allowing a user to play a virtual live action sports game on a network-connected device, the method comprising the steps of:
selecting a virtual team of players from two or more of teams of a live action sports games; and
determining a virtual team score as a sum of points actually scored by the virtual team of players and bonus points for team play that directly contributes to scoring and/or the prevention of scoring.

2. The method of claim 1 further comprising providing a display of one or more of the live action sports games

3. The computer-based data processing method of claim 1 further comprising the step of:
determining player bonus points based on popularity of a player, said player bonus points being included as a factor in said step of determining said virtual team score.

4. The computer-based data processing method of claim 1 further comprising the step of:
substituting one or more players of said virtual team of players.

5. The computer-based data processing method of claim 1 further comprising the step of:
calling one or more plays used in said live action sports games and points being included as a bonus factor in said step of determining said virtual team score if said one or more plays is called for the virtual team of players.

6. The computer-based data processing method of claim 1 further comprising the step of:
calling one or more play risks taken in said live action sports games and points being included as a bonus factor in said step of determining said virtual team score if said one or more play risks is called for the virtual team of players.

7. The computer-based data processing method of claim 1 further comprising the step of:
calling one or more substitute players to participate in a play call in said live action sports games and points being included as a bonus factor in said step of determining said virtual team score if said one or more substitute players participate in the selected play call for the virtual team of players.

8. The computer-based data processing method of claim 1 wherein the virtual team of players is selected for two teams based on a half of the players coming from each team.

9. The computer-based data processing method of claim 1 wherein the bonus points are based on a score contributing defensive contribution.

10. The computer-based data processing method of claim 1 further comprising the step of:
transforming computer memory to represent the virtual team score.

11. The computer-based data processing method of claim 1 further comprising the step of:
determining a ranking of the virtual team score in comparison to a ranking of one or more competitor virtual team scores; and
displaying the ranking of the virtual team score.

12. The computer-based data processing method of claim 1 further comprising:
displaying elapsed time in said one or more live action sports games.

13. The computer-based data processing method of claim 1 wherein the live action sports games include professional American football teams, professional baseball teams, professional hockey teams and professional soccer teams.

14. The computer-based data processing method of claim 1 further comprising:
controlling the display of the one or more live action sports games.

15. The computer-based data processing method of claim 1 wherein the display is displayed on a mobile application and the selection of the virtual team and the determination of the virtual team score is determined with the mobile application.

16. The method of claim 1 wherein said virtual team score is determined by receiving statistics via a communication medium in real time and analyzing the received statistic to determine the virtual team score.

17. A computer-based data processing system for allowing a user to play a virtual live action sports game on a network-connected device, the system comprising:
a display for displaying one or more live action sports games;
a central processor for receiving team data of the live action sports game and processing the team data;
an input device for selecting a virtual team of players from two or more of the live action sports games as user data
storage for storing the team data and the user data; and
means for determining a virtual team score as a sum of points actually scored by the virtual team of players and bonus points for team play that directly contributes to scoring and/or the prevention of scoring from the user data and the team data.

18. A non-transitory computer-usable medium having computer readable instructions stored thereon for execution by a processor to perform a method comprising the steps of:
providing a display of one or more live action sports games,
selecting a virtual team of players from two or more of the live action sports games; and
determining a virtual team score as a sum of points actually scored by the virtual team of players and bonus points for team play that directly contributes to scoring and/or the prevention of scoring.
